(19) United States
(12) Patent Application Publication
(10) Pub. No.: US 2008/0041400 A1
(43) Pub. Date: Feb. 21, 2008

(54) System and Process for Custom Molding Dental Trays

(76) Inventor: Daniel H. Darnell, Cullman, AL (US)

Correspondence Address: LANIER FORD SHAVER & PAYNE P.C., P O BOX 2087, HUNTSVILLE, AL, 35804-2087, US

(21) Appl. No.: 11/840,102

(22) Filed: Aug. 16, 2007

Related U.S. Application Data
(60) Provisional application No. 60/838,239, filed on Aug. 17, 2006.

(51) Int. Cl. A61C 5/14

(52) U.S. Cl. 128/862; 433/37

(57) ABSTRACT

A system and method for custom molding dental trays is disclosed. The system includes a hot air source and heat chamber, wherein a thermoformable dental tray is placed within the heat chamber and heated to the appropriate temperature. The heat chamber may include air escape holes to allow for uniform heating. Furthermore, the heat chamber may incorporate a fan or other air removal device to improve uniform heating.

### CROSS-REFERENCE TO RELATED APPLICATION

This application claims priority to U.S. provisional application Ser. No. 60/838,239, filed Aug. 17, 2006, and which is incorporated by reference herein.

### BACKGROUND OF THE DISCLOSURE

This disclosure generally relates to customized dental trays which can be used as protective mouthpieces or for dental treatments. In particular, the present disclosure relates to a system and process for custom molding dental trays.

The need for custom fitted oral appliances is well known. Protective mouthpieces or mouthguards are used by athletes to protect against injury. Dental trays are also used for bleaching, administration of fluoride, or application of other medicines. Various custom fitted dental trays including mouthguards are known in the art. One of the most common products on the market today is the “boil and bite” dental tray, which is made out of a thermoformable plastic such as ethyl vinyl acetate (“EVA”) or polyethylene. A customized tray is created by heating the plastic in boiling water causing it to melt at a biologically acceptable temperature, and then placing it directly over an individual's teeth where it cools and retains its new shape.

The “boil and bite” method is very convenient and simple as it eliminates the expensive and lengthy process of creating an impression of the teeth, which is used to fabricate a model over which a thermoformed plastic tray is formed. However, a limitation of the “boil and bite” method is that a source and reservoir of boiling water is required to soften the dental tray material and make it moldable. An improvement in the art involves creating a method which does not require boiling water and which is able to evenly soften a thermoformable, universal fitted, blank dental tray such that it can be molded and permanently adapted to the teeth of an individual user.

### SUMMARY OF THE DISCLOSURE

The present disclosure recognizes and addresses various of the foregoing limitations and drawbacks, and others, concerning the system and process of creating a custom fitted dental tray. Therefore, the present disclosure is directed to a system and process that satisfies this need.

It is, therefore, a principle object of the subject disclosure to provide a system which is able to evenly soften a thermoformable dental tray through the use of hot air and without any boiling water such that it can be molded and permanently adapted to the teeth of an individual user.

It is a further object of this present disclosure to provide a process for evenly softening a thermoformable dental tray through the use of hot air and without any boiling water so that it can be molded and permanently adapted to the teeth of an individual user.

The process of using heat transferred through air is advantageous because a source and reservoir of boiling water would no longer be needed. Also, the system which heats the dental tray is advantageous because it can be produced as a small portable unit that can be stored and used in professional offices or by the user. There would no longer be a need to keep water boiling or to wait for it to boil. The unit could easily begin generating hot air within a short period of time.

Additional objects and advantages of the disclosure are set forth in, or will be apparent to those of ordinary skill in the art from, the detailed description as follows. Also, it should be further appreciated that modifications and variations to the specifically illustrated and discussed features and materials hereof may be practiced in various embodiments and uses of this disclosure without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this disclosure, may include various combinations or configurations of presently disclosed features, elements, or their equivalents (including combinations of features or configurations thereof not expressly shown in the figures or stated in the detailed description).

These and other features, aspects and advantages of the present disclosure will become better understood with reference to the following descriptions. The accompanying drawings, which are incorporated in and constitute a part of this specification, illustrate an embodiment of the disclosure and, together with the descriptions, serve to explain the principles of the disclosure.

One embodiment of the present disclosure is a process for evenly heating a thermoformable dental tray to make it moldable with hot air. The process provides a lid with air escape holes from which the blank thermoformable dental tray is suspended. This lid is placed on one end of a heat chamber which also contains air escape holes. A hair dryer or similar hot air source is then placed on the opposite end of the heat chamber and generates a hot air flow. This hot air flow heats the dental tray until it is moldable.

Another embodiment of the present disclosure is a process for evenly heating a thermoformable dental tray with hot air, further including a fan for removing the hot air from the system. The air removal fan can either be located on the side of the heat chamber or on top of the lid, and it helps to more efficiently and evenly heat the dental tray by increasing the turbulent air flow in the system. This increased air flow also prevents the system from overheating.

### BRIEF DESCRIPTION OF THE DRAWINGS

A full and enabling description of the present disclosure, including the best mode thereof, directed to one of ordinary skill in the art, is set forth in the specification, which makes reference to the appended figures, in which:

FIG. 1 is a perspective view of a blank, thermoformable dental tray which is to be custom fitted to an individual's teeth;

FIG. 2 is a perspective exploded view of an exemplary system for custom molding dental tray such as is depicted in FIG. 1;

FIG. 3 is a top view of the lid of the system depicted in FIG. 2;

FIG. 4 is a perspective view of the assembled system for custom molding dental trays as depicted in FIG. 2;

FIG. 5 is a perspective exploded view of another exemplary system for custom molding dental trays, further including an air removal fan.

FIG. 6 is a perspective view of the assembled system as depicted in FIG. 5.

FIG. 7 is a front view of the air removal fan of the system depicted in FIG. 5.

Repeat use of reference characters throughout the present specification and appended drawings is intended to represent the same or analogous features or elements of the disclosure.

### DETAILED DESCRIPTION OF THE PREFERRED EMBODIMENTS

Reference will now be made in detail to embodiments of the disclosure, examples of which are fully represented in the accompanying drawings. Such examples are provided by way of an explanation of the disclosure, not limitation thereof. In fact, it will be apparent to those skilled in the art that various modifications and variations can be made in the present disclosure, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present disclosure cover such modifications and variations as come within the scope of the present features and their equivalents.

As disclosed above, the present disclosure is particularly concerned with custom fitted dental trays. In one aspect, the disclosure relates to the process of evenly heating a thermoformable dental tray with air, making it moldable so it can be placed over an individual's teeth where it will cool and permanently adapt to that new shape. In another aspect, the disclosure relates to a system which evenly heats a thermoformable dental tray with hot air, making it moldable so it can be placed on an individual's teeth and permanently adapt to its new shape as it cools. The resulting trays can be used as protective mouthguards or for dental treatment, such as bleaching, fluoride treatments, and antimicrobial treatments. Reference is now made to the drawings.

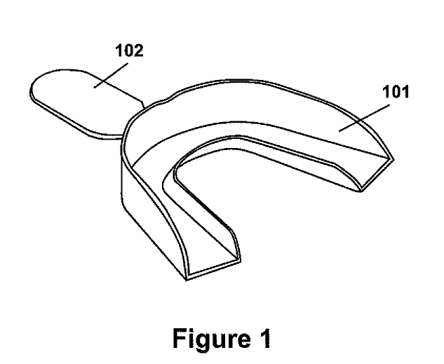

FIG. 1 depicts a preformed, blank dental tray 101 that may be used to manufacture a customized dental tray by heating the dental tray 101. In this regard, the dental tray 101 may be heated according to the process of the present disclosure, and then placed over the individual's teeth.

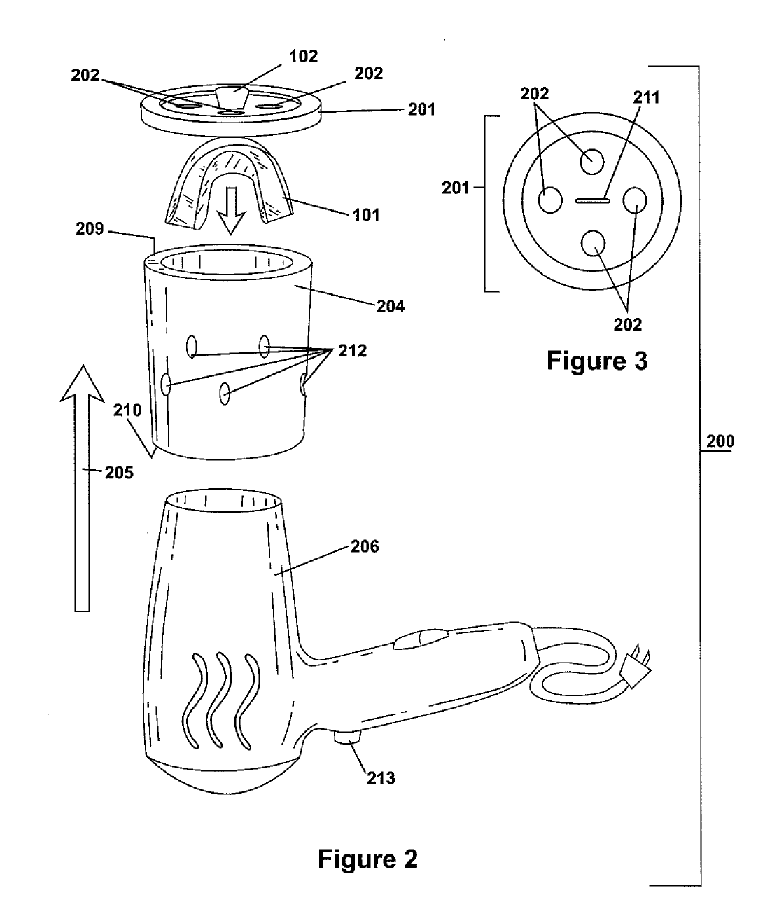

Once it is cooled, and the dental tray 102 will permanently adapt to the shape of the individual's teeth. In one embodiment, the dental tray 101 is attached to a detachable handle 102. The detachable handle 102 is described further herein with reference to FIG. 2. The dental tray 101 can be made of any appropriate thermoformable material which softens at a temperature that is greater than body temperature.

FIG. 2 depicts a system 200 in accordance with an embodiment of the present disclosure for heating a thermoformable dental tray 101. The system 200 comprises a lid 201, and a heat chamber 204. In one embodiment, the system 200 further comprises a hot air source 206.

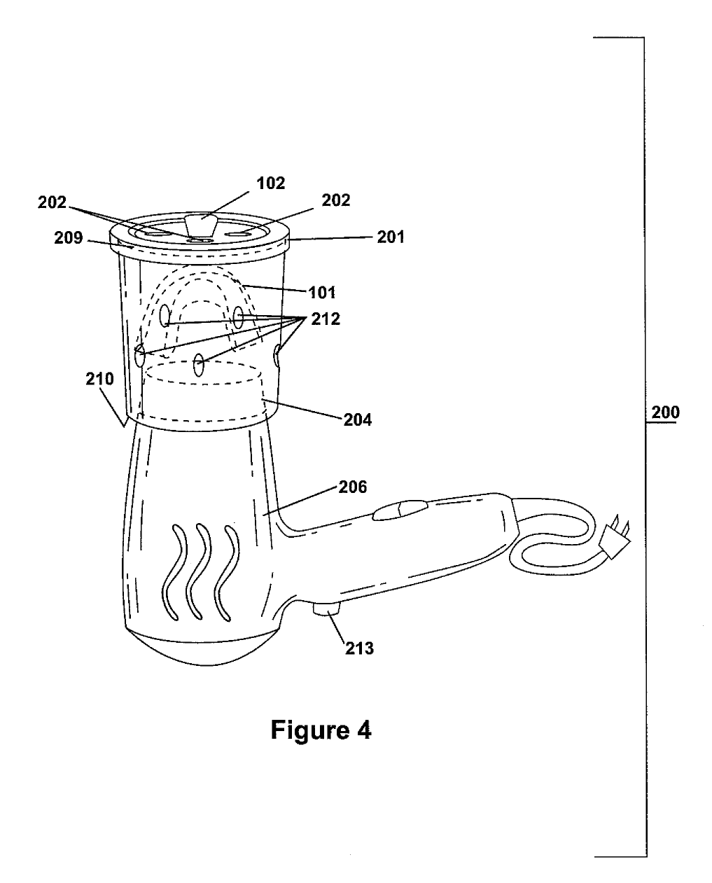

As stated hereinabove, the dental tray 101 may be attached to a detachable handle 102. In such an embodiment, the handle 102 couples with a slot 210 of the lid 201. As an example, the detachable handle 102 is inserted in a slot 211 in the lid 201. In an alternative embodiment, the dental tray 101 may be suspended in the heat chamber 204 through any other suitable method. The lid 201 further has air escape holes 202 to allow for the circulation of air. With reference to FIG. 3, the slot 211 and air escape holes 202 are disclosed. As will be shown with reference to FIG. 4, The lid fits securely on an end 209 of the heat chamber 204 in order to withstand forces placed upon it from air from the hot air source 201.

In an alternative embodiment, the lid 201 may be secured to the heat chamber by fasteners, clasps, or latches. Notably, the lid 201 may be secured to the chamber 204 via any method, mechanism or device now known or future-developed that would ensure that the lid 201 remains attached while air from the source 206 is heating the lid 201. In one embodiment, the heat chamber 204 has air escape holes 212. The holes 212 allow for the circulation of hot air which aids in the even heating of the dental tray 101, as described further with reference to FIG. 4. In another embodiment, the heat chamber 204 is insulated and may be made from a standard soda can insulator or koozie, such as high density foam, neoprene, or any other suitable insulating material capable of withstanding the forces and heat placed upon it. Further, the heat chamber 204 may be coated with an insulating paint.

The hot air source 206 depicted in FIG. 2 is a standard hair dryer capable of generating a hot air flow of up to 200 degrees Fahrenheit. The hot air source 206 is placed on an end 210 of the heat chamber 204 opposite the end 209 coupled to the lid 201. In one embodiment, the hot air source 206 is tapered to fit within the heat chamber 204 to promote the efficient operation of the system by ensuring all of the hot air from the hot air source is directed toward the dental tray 101. When the hot air source 206 is activated, the hot air source 206 forces hot air through the heat chamber 204 toward the dental tray 101 in the direction shown by reference arrow 205. The air escape holes 202 in the lid 201 and in the air escape holes 212 in the heat chamber 204 allow for the proper circulation of air and create a turbulent fluid flow which evenly heats the dental tray 101. The air escape holes 202 further control the build-up of pressure in the heat chamber 204.

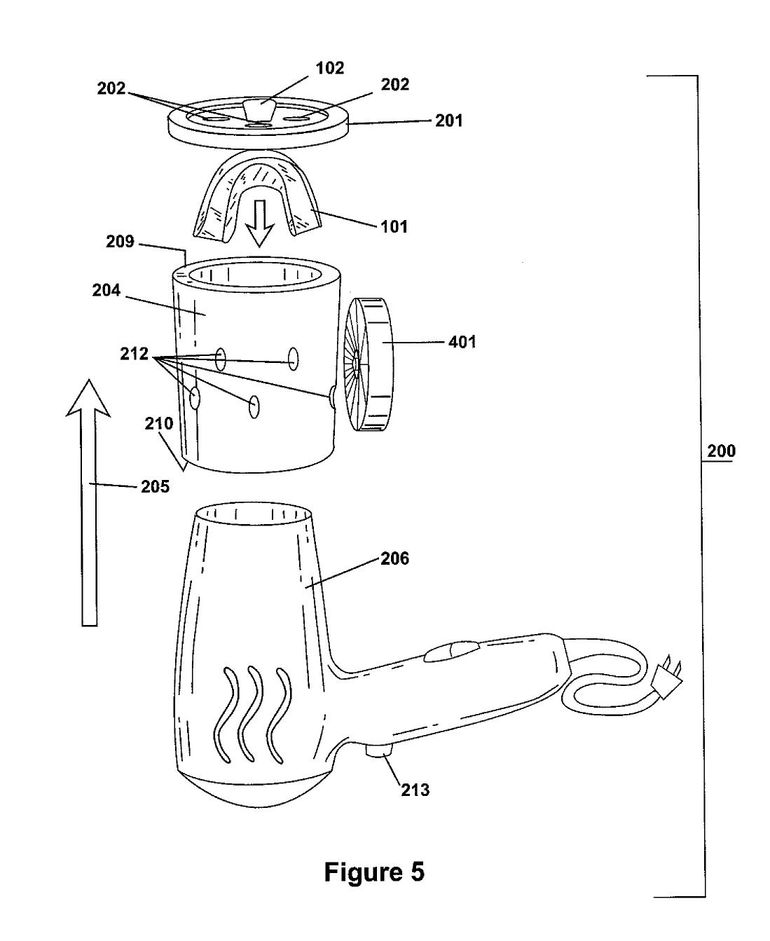

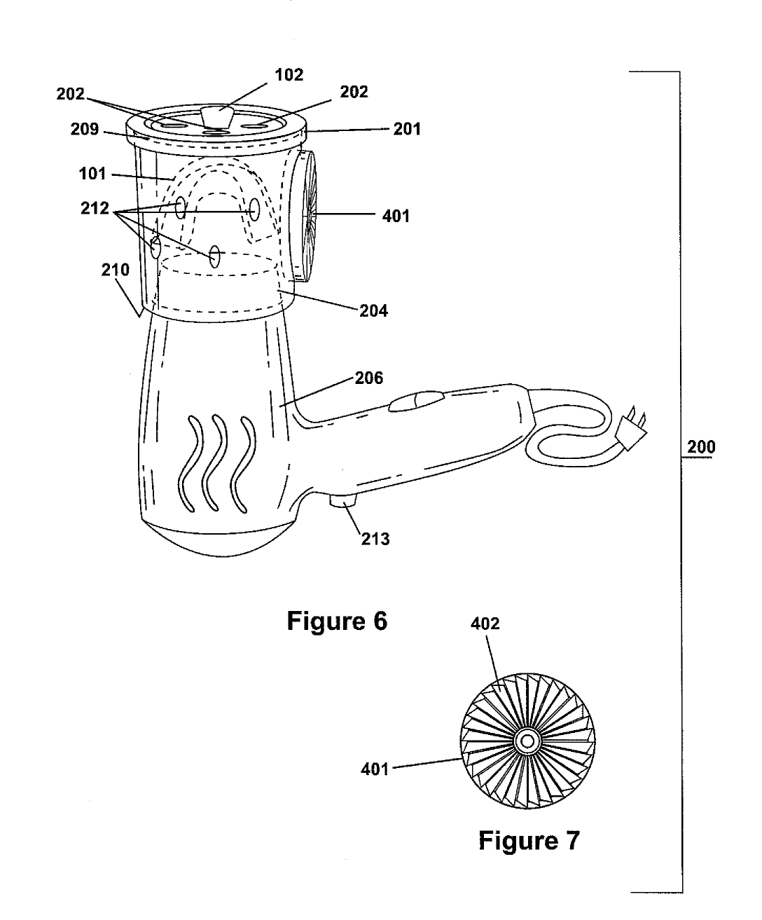

FIGS. 5 and 6 depict another embodiment of the present disclosure, in which an air removal fan 401 is located on the heat chamber 204 in order to adjust the circulation of air through the system 200. FIG. 6 displays the system 200 in which the fan 401 is securely fitted into a larger opening on the side of the heat chamber 204. The fan 401 helps to evenly heat the dental tray 101 by maintaining a turbulent flow of air through the system 200. In an alternative embodiment, the air removal fan 401 can be placed on top of the lid 201, or incorporated into the lid 201 to accomplish the same result.

FIG. 7 depicts a front plan view of the air removal fan 401 in operation. The number of blades 402 on the fan 401 can be varied in order to accomplish the desired results.

The time the dental tray 101 remains in this system 200 is determined by the temperature produced by the hot air source 206 and the temperature maintained in the heat chamber 204. The desired temperature of the heat chamber 204 will depend upon the material of the dental tray 101. In one embodiment, the dental tray is made of EVA, and should be heated for 90 seconds once the heat chamber reaches 145 degrees Fahrenheit.

Once the dental tray 101 reaches the desired temperature, it is placed over the user's teeth. The user bites down on the dental tray 101 and uses his tongue or finger to form the dental tray 101 to the shape of his or her teeth. Once the dental tray 101 has cooled to an appropriate temperature, it will retain shape of the user's teeth.

In an alternative embodiment the hot air source 206 can be equipped with a variable temperature control device 213 which can be used to maintain the desired temperature in the heat chamber 204. The temperature of the heat chamber 204 may be monitored by a thermostat (not pictured) and relayed to the hot air source 206 in order to maintain a desired temperature.

Although an embodiment of the disclosure has been described using specific terms and devices, such description is for illustrative purposes only. The words used are words of description rather than of limitation. It is to be understood that changes and variations may be made by those of ordinary skill in the art without departing from the spirit or the scope of the present disclosure. In addition, it should be understood that aspects of various other embodiments may be interchanged either in whole or in part. Therefore, the spirit and scope of any appended claims should not be limited to the description of any embodiment contained herein.

I claim:

1. A method for heating a dental tray with hot air comprising the steps of:
a. inserting said dental tray within a substantially closed chamber; and
b. delivering said hot air to said substantially closed chamber until said dental tray becomes deformable.

2. The method of claim 1 further comprising the step of providing a lid coupled to said dental tray wherein said dental tray is disposed within said substantially closed chamber and said lid fits securely to said substantially closed chamber.

3. The method of claim 2 further comprising the step of circulating said hot air via a plurality of air escape holes in said lid.

4. The method of claim 1 wherein said delivering step is accomplished by providing a hot air source coupled to said substantially closed chamber.

5. The method of claim 4 wherein said delivering step further comprises the step of delivering hot air with a hair dryer.

6. The method of claim 4 further comprising the step of controlling the temperature of the air produced by said hot air source with a variable temperature control device.

7. The method of claim 1 wherein said substantially closed chamber contains a plurality of air escape holes.

8. The method of claim 1 wherein said substantially closed chamber is insulated by high-density foam.

9. The method of claim 1 wherein said substantially closed chamber is composed of high-density foam.

10. The method of claim 1 further comprising the step of removing air from said heat chamber with a fan.

11. The method of claim 10 wherein said fan is integrated within said heat chamber.

12. The method of claim 10 wherein said fan is integrated within said lid.

13. A dental tray molding system comprising:
a. a substantially closed chamber, said substantially enclosed chamber housing a dental tray; and
b. a hot air source interfaced with said substantially closed chamber such that hot air enters said substantially closed chamber and softens said dental tray;

14. The system of claim 13 wherein said dental tray is secured to a lid, and wherein said lid is coupled to said substantially closed chamber such that said dental tray is disposed within said substantially closed chamber.

15. The system of claim 14 further comprising a fan for removing air from said substantially closed chamber.

16. The system of claim 15 wherein said fan is integrated within said lid.

17. The system of claim 14 further comprising a handle immovably affixed to said dental tray, wherein said handle couples to said lid.

18. The system of claim 17 wherein said lid contains a plurality of air escape holes.

19. The system of claim 13 wherein said hot air source is a hair dryer.

20. The system of claim 13 wherein the temperature of the air produced by said hot air source may be controlled by a variable temperature control device.

21. The system of claim 13 wherein said substantially closed chamber contains a plurality of air escape holes.

22. The system of claim 13 wherein said substantially closed chamber is insulated by high-density foam.

23. The system of claim 13 wherein said substantially closed chamber is composed of high-density foam.

24. The system of claim 13 further comprising a fan for removing air from said substantially closed chamber.

25. The system of claim 24 wherein said fan is integrated within said substantially closed chamber.

26. A device for heating a dental tray with hot air comprising:
a. means for producing hot air;
b. means for suspending said dental tray within a substantially closed chamber; and
c. means for controlling air flow in said substantially closed chamber.
